(19) United States
(12) Patent Application Publication
(10) Pub. No.: US 2016/0116214 A1
(43) Pub. Date: Apr. 28, 2016

(54) MULTILAYER COOLING PANEL AND ELECTRIC ARC FURNACE

(71) Applicant: REFRACTORY INTELLECTUAL PROPERTY GMBH & CO. KG, Wien (AT)

(72) Inventor: Marcus Kirschen, Seckau (AT)

(21) Appl. No.: 14/891,006

(22) PCT Filed: Apr. 17, 2014
(86) PCT No.: PCT/EP2014/057906

§ 371 Date: Nov. 13, 2015

(30) Foreign Application Priority Data
Jun. 28, 2013 (EP) 13174259.5

(51) Int. Cl. F27D 1/12; F27B 3/08; F27B 3/16; F27B 3/24

(52) U.S. Cl. CPC F27D 1/12; F27B 3/24; F27B 3/085; F27B 3/16; F27D 2009/0002

(57) ABSTRACT

The invention relates to a multilayer cooling panel for an industrial furnace such as an electric arc furnace.

The invention relates to a multilayer cooling panel for an industrial furnace such as an electric arc furnace and the furnace itself. Prior art panels and panels according to the invention will be described hereinafter with respect to such an electric arc furnace (EAF) but without limiting the scope of the invention to this furnace type.

The overall design of such an EAF typically comprises:
a so-called hearth, defining a lower part of the furnace in its regular use position, and comprising a hearth wall with an inner refractory ceramic lining as a protective cover against the hot metal medium treated within the hearth,
an upper shell, defining an upper part of the furnace in its regular use position and arranged above the hearth wall,
a removable roof, comprising electrodes.

The upper shell acts as an outer sidewall of the furnace.

Numerous proposals have been made with respect to the construction of this upper furnace shell which on the one hand must protect the furnace surrounding area against metallurgical spill and on the other hand provide best possible insulation properties in view of the total energy consumption of the furnace.

One common design is characterized by a row of lateral panels which are arranged substantially on top of the upper edge of the lower shell (the hearth wall).

According to EP 0790473 B1 these panels provide a cooling device, characterized by an outer layer and at least one inner layer of cooling tubes, wherein said layers are separated by an interspace. This interspace allows slag to enter during the melting process and to be retained within said interspace.

For this reason the outer layer is designed with the cooling tubes adjacent to each other, while the inner layer of the panel includes the cooling tubes separated from each other to allow the slag to enter via spaces between said cooling tubes.

The aim of this design is to use the insulation properties of the solidified slag but said slag only has a low melting temperature and its composition is more or less aggressive vis-a-vis the metallic cooling tubes.

In this respect it is known from practice to fill-up the said interspace with a monolithic refractory material at least partially. The refractory filling avoids a direct contact between the slag and the cooling pipes over a certain period of time until the refractory monolithic material has been worn to such extent that it cannot fulfil this task anymore.

A problem in using a gunned basic refractory material adhering to the cooling tubes is the different thermal expansion coefficient of such MgO-based gunning material and the metallic cooling pipes, which leads to spalling. The replacement of the basic gunning material by a non-basic refractory material such as alumina (Al₂O₃) is not suitable as it is not stable against basic process slags in the furnace.

Therefore it is an object of the invention to provide a cooling device of improved properties over said prior art designs and in particular to provide a cooling device providing an energy-saving potential for the industrial furnace.

The invention is based on the following findings:
Efficient cooling along the upper shell of an EAF is an important factor to achieve reliable and long-term stability and availability of the upper part of the EAF. A water-cooled system has proved of that value insofar but is subject to a multitude of stresses during service.
During trials it derived from this cognition that the protection of the cooling device (the cooling tubes) plays an important role to decrease heat flow to the cooling fluid and to decrease energy losses of the EAF.
In further trials it was found that it is not necessary to protect the cooling tubes by applying a lining material such as a refractory monolithic or a metallurgical slag directly onto the tubes' surfaces but to provide a thermal, chemical and
metallurgical barrier in front of it (i.e. between furnace chamber and cooling pipes).
This led to a construction with a barrier of pre-shaped refractory ceramic plates.

They may be designed as well as larger or relatively small units, thereby reducing the risk of crack formation and can be made of any refractory mix (batch composition), as they are not applied as a lining material onto any other construction element but simply clamped, hanged, cramped or fixed by any other means to corresponding construction parts. A detachable/suspended fixture is preferred.

These refractory plates, as an inner layer of corresponding panel structure, protect the outer panel layer, namely the cooling structure, very efficiently. The plates provide an efficient screening wall against thermal radiation, even high energy radiation deriving from unshielded electric arcs or even arcing. They further allow a space of arbitrary size between refractory plates and cooling tubes, serving as an insulation space.

The refractory plates further fulfil the function to absorb any slag splashing against said plates and insofar again protect the cooling device from any metallurgical attack.

By corresponding fixture means—an example is shown in the attached drawing—even cracks in one or more plates do not disintegrate the construction. In the worst case the plates can easily be replaced.

In its most general embodiment the invention relates to a multilayer cooling panel for an industrial furnace, comprising:
A first layer, built of one or more cooling pipes and providing an outer layer of the cooling panel, when mounted to the industrial furnace,
a second layer, built of at least one refractory plate and providing an inner layer of the cooling panel, when mounted to the industrial furnace, wherein
said first layer and said second layer are arranged in a defined position to each other.

Depending on the shape of the refractory plates and the cooling pipes the outer side of said plates, facing the cooling pipes, may follow the shape of the cooling pipes although it is preferred to either provide a gap between cooling pipes and refractory plates and/or to use refractory plates with a more or less planar outer surface which design immediately leads to a corresponding space between the outer surface of the refractory plates and the corresponding surface sections of the cooling pipes (under the proviso of pipes of circular cross section).

The cooling pipe(s) of the first layer may be arranged in a meandering fashion to provide a substantially continuous cooling layer. In other words: There is no or only little space between adjacent sections of the cooling pipes.

This design will be preferred in case of lack of any further outer wall section as part of the upper furnace shell and its panels respectively.

In another embodiment the upper shell is further characterized by separate outer closed wall to which the cooling panels may be mounted.

In a third embodiment adjacent pipe sections of the panels are bridged by fins to provide a more or less closed layer.

Although it has advantages to use relatively small refractory plates (base area less than 1 m², <0.5 m²′<0.3 m² or even <0.1 m²) the invention is applicable as well with larger refractory plates or even with one refractory plate per panel.

Depending on the number and size of the refractory plates it is possible to provide a substantially continuous layer design for said second layer, similar to a tiled wall, wherein joints between adjacent plates may be open.

The space between refractory ceramic plates (inner layer) and cooling pipes (outer layer) may remain empty of may be filled by a suitable material like a high temperature resistant fibre material (ceramic fibres, mineral fibres), wherein high temperature refers to temperatures above 800° C.

Typically, the first and second layer are arranged at a distance to each other, as mentioned above but the invention includes an embodiment wherein the first and the second layer contact each other at least partially.

This includes an embodiment wherein the at least one refractory plate is fixed at the first layer, preferably in a detachable manner. This can be achieved by hooks, anchors or the like, protruding towards the refractory plates from the inner surface of the cooling tubes onto which the refractory plates are hung, onto which the refractory plates are placed or between which the refractory plates arranged, for example by clamping.

The arrangement and fixation of the refractory plates may also be achieved in an embodiment comprising a third layer, arranged at a distance to the first layer and housing the second layer between said first and third layer.

The third layer may cover only part of the second layer, for example <10%, <20% or <30% of the surface area of the second layer.

This can be achieved by further cooling pipes (tubes) or corresponding rails which are fixedly secured or functionally attached to the first layer. At least one possible embodiment is shown in the drawing hereinafter.

This design allows to clamp the refractory plates of the second layer between said first and third layer with further advantages in mounting and replacing said plates in case of need.

In order to avoid any stresses between adjacent refractory plates the invention includes an arrangement with a little gap between adjacent refractory plates.

In view of their high melting temperature and resistance against basic process slags basic refractory materials have advantages over non-basic compositions.

A refractory material based on magnesia (MgO) or doloma (MgO CaO) is recommended.

In case of low or no carbon content within these refractory batches low thermal conductivities may be achieved as well as a good stability against oxidation, with the advantage of high energy efficiency and high metallurgical stability.

The refractory plates may have a flat or profiled surface structure. A profile structure on its surface opposite to the first layer (meaning: towards the furnace chamber) allows the slag to better adhere onto the refractory plates, thus providing a further insulation layer.

The profiled surface structure may be achieved by at least one of the following features: protrusion, depression, tongue, groove, grate structure, bolt, anchor.

The overall operation mode of the furnace, especially the electric arc furnace, is by no means influenced by the lifetime of the new multilayer cooling panels as these plates may be replaced at any time without demounting the entire upper shell, partially (only one or more plates) or completely. Larger repair actions as in prior art constructions may be avoided. The first layer (water cooled tubes) remain intact/functional when the second layer (refractory plates) is damaged and must be replaced.

The refractory plates, typically of rectangular or hexagonal/polygonal shape, are easy and cheap to produce.

It is even possible to provide the refractory plates with an inherent carbon gradient, namely a carbon free side (the cold side with a low thermal conductivity) and a carbon containing side (the hot side) of increased slag resistance.

Typically dimensions of the refractory plates may be (L=length, W=width, T=thickness)

L: 200-1.000 mm, in particular 250-600 mm.
W: 200-1.000 mm, in particular 250-600 mm.
T: 5-100 mm, in particular 20-70 mm.

The invention further comprises an EAF including at least one of said cooling panels along its upper shell. In this respect it is to be understood that only part of the upper shell may be constructed with the panels described.

Further features of the invention may be derived from the sub-claims and the other application documents, including the following schematic drawing and its description.

In the drawing the following is shown:

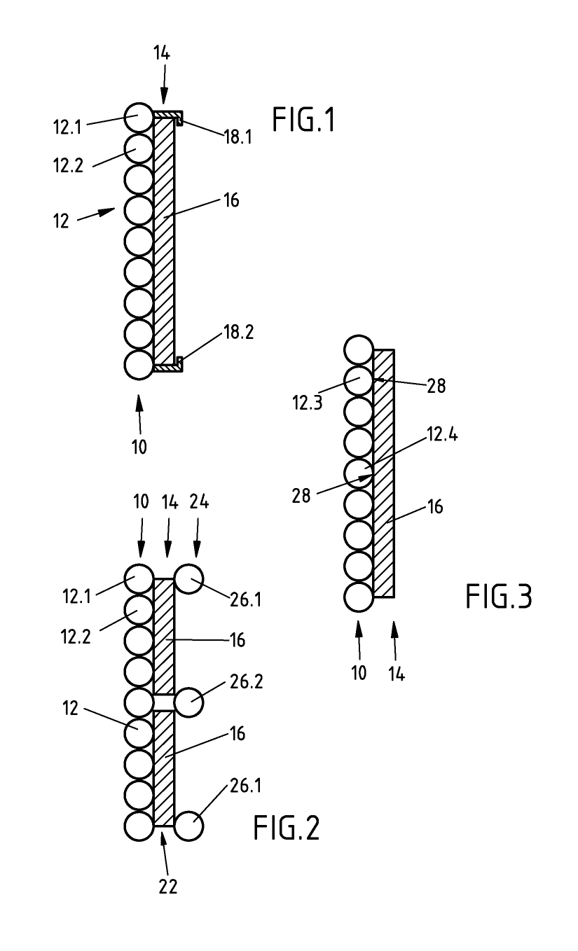

FIG. 1: A longitudinal sectional view of a first embodiment of a multilayer cooling panel.

FIG. 2: A view according to FIG. 1 of a second embodiment.

FIG. 3: A view according to FIG. 1 of a third embodiment.

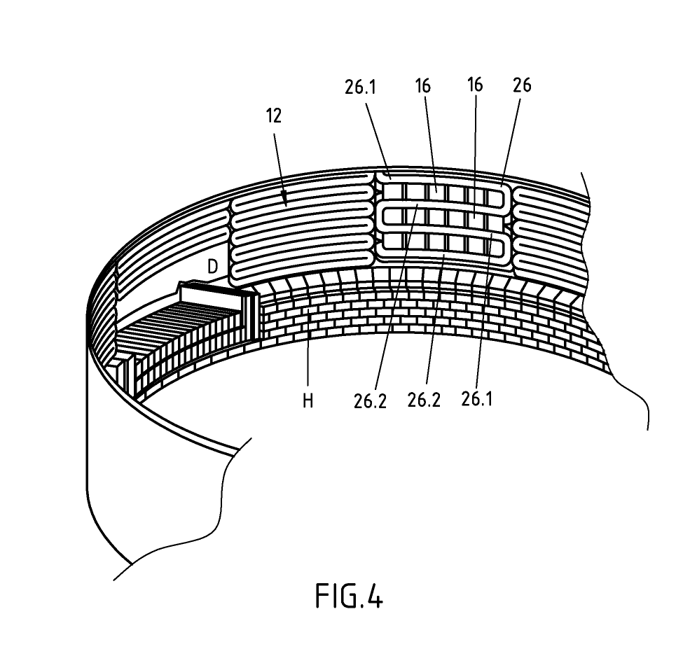

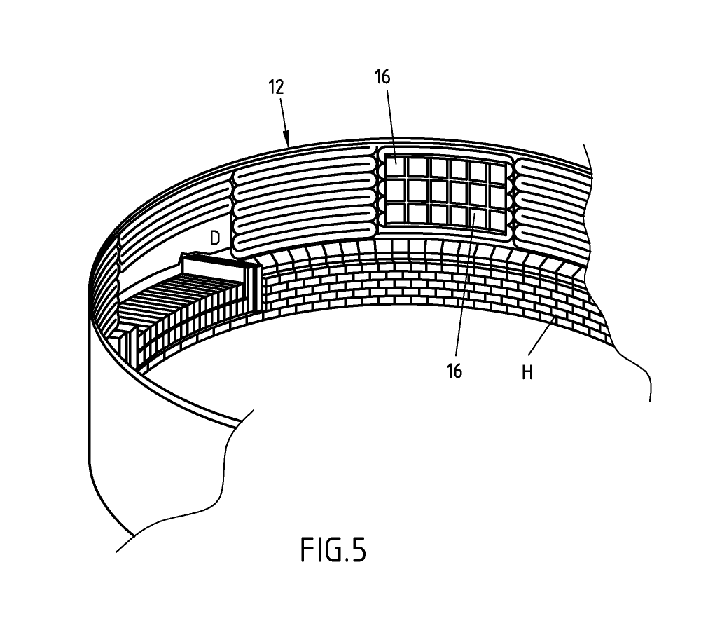

FIG. 4: A perspective view from the inner furnace chamber onto the lower wall section of the furnace hearth and its upper shell with a panel according to FIG. 2.

FIG. 5: A view as in FIG. 4 with a panel according to FIG. 3.

FIG. 1 discloses a first embodiment of a multilayer cooling panel for an electric arc furnace. This panel comprises a first layer 10, built of one cooling pipe 12, which provides an outer layer of the cooling panel when mounted to an EAF.

The cooling pipe 12 is designed in a meandering fashion as shown in the left part of FIG. 4 by arrow 12. Adjacent sections 12.1, 12.2, . . . of said cooling pipe 12 touch each other so that a substantially closed outer layer 10 being provided.

As best seen from FIG. 1, L-shaped rails 18.1, 18.2 are welded onto the uppermost and lowermost section of cooling pipe 12 and arranged in a distance to each other to accommodate refractory plates 16 in-between. The rails 18.1, 18.2 may be hollow and water cooled. Options are rails made of a material of high heat conduction, e. g. copper.

In order to arrange said plates 16 in the desired orientation the free leg of lower rail 18.2 is shorter than that of the upper rail 18.1.

The refractory plates 16 provide a second, inner layer 14 of the panel in its mounted state, which is shown in connection with a different embodiment in FIG. 4.

The embodiment according to FIG. 2 differs from that of FIG. 1 especially by the following means:

The second layer 14 is made of smaller refractory plates 16.

The panel of FIG. 2 comprises a third (vertical) layer 24, provided by cooling pipe sections 26.1, 26.2 of a meandering cooling pipe 26 vertically arranged at a distance to each other and in fluidic connection with cooling pipes 12 of said first layer 10.

The said cooling pipe sections 26.1, 26.2 are arranged at a distance to said first layer 10, thereby allowing the refractory plates 16 to be arranged within a space 22 between first layer 10 and second layer 24.

The embodiment of FIG. 2 is characterized by linear contact lines between cooling pipe sections 12.1, 12.2/26.1, 26.2 and refractory plates 16. Nevertheless the refractory plates 16 are arranged over most of their surface area at a distance to said cooling pipe sections 12.1, 12.2/26.1, 26.2.

The embodiment of FIG. 3 is functionally equivalent to that of FIG. 2 with the proviso that the refractory plates 16 are hung onto bolts 28 onto corresponding sections 12.3, 12.4 of cooling pipe 12.

FIG. 4 is a view from the inner furnace chamber towards the corresponding wall region.

H represents the upper end of the furnace hearth, made of refractory bricks, followed upwardly by the so-called upper shell of the furnace, comprising panels 10 according to the invention.

For a better understanding only one of these panels (in the middle of FIG. 4) is represented in a design according to the invention, namely according to the embodiment of FIG. 2, whereas the panels to the left and to the right represent conventional panels or the first layer 10 of an inventive panel respectively.

Connections to the cooling medium, especially water, are not shown.

On the very left of FIG. 4 a deslagging door (D) of the EAF may be seen.

According to FIG. 4 about 90% of the overall inner surface of panel 10 is covered by refractory plates 16, which panels are arranged at a small distance to each other to avoid any cracks under thermal expansion during use.

Pipe sections 26.1, 26.2 may be seen, acting as clamping means for the refractory plates 16.

Any slag will either hit the refractory plates 16 or the cooling pipe sections 26.1, 26.2 instead of the cooling pipe 12 of the first layer 10 and thus increase the overall lifetime of said panel.

The refractory plates 16 are made of an MgO-based ceramic material in accordance with the general description above. This is true as well with respect to its profiled surface.

FIG. 5 shows a view according to FIG. 4 with a cooling panel as disclosed in FIG. 3.

1. Multi-layer cooling panel for an industrial furnace, comprising
a) a first layer (10), built of one or more cooling pipes (12) and providing an outer layer of the cooling panel when mounted to the industrial furnace,
b) a second layer (14), built of at least one refractory plate (16) and providing an inner layer of the cooling panel when mounted to the industrial furnace, wherein
c) said first layer (10) and second layer (14) are arranged in a defined position to each other.

2. Multi-layer cooling panel according to claim 1, wherein the cooling pipes (12) of the first layer (10) are arranged in a meandering fashion to provide a substantially continuous layer design.

3. Multi-layer cooling panel according to claim 1, wherein adjacent pipe sections are bridged by fins.

4. Multi-layer cooling panel according to claim 1 with a second layer (14) of multiple refractory plates (16) arranged to provide a substantially continuous layer design.

5. Multi-layer cooling panel according to claim 1, wherein the first (10) and second (14) layer are arranged at a distance to each other.

6. Multi-layer cooling panel according to claim 1, wherein the first (10) and the (14) second layer contact each other at least partially.

7. Multi-layer cooling panel according to claim 1, wherein the first layer (10) comprises a wall, covering the one or more cooling pipes opposite to the second layer (14).

8. Multi-layer cooling panel according to claim 1, wherein the at least one refractory plate (16) is fixed at the first layer (10) in a detachable manner.

9. Multi-layer cooling panel according to claim 1, comprising a third layer (24), arranged at a distance to the first layer (10) and housing the second layer (14) between said first (10) and third (24) layer.

10. Multi-layer cooling panel according to claim 9 with the refractory plate(s) (16) of the second layer (14) clamped between first (10) and third (14) layer.

11. Multi-layer cooling panel according to claim 9, wherein the third layer (24) covers only part of the second layer (14)

12. Multi-layer cooling panel according to claim 1, with at least one refractory plate (16) has a profiled structure on its surface opposite to the first layer (10).

13. Multi-layer cooling panel according to claim 12, wherein the profiled surface structure is achieved by at least one of the following features: protrusion, depression, tongue, groove, grate structure, bolt, anchor.

14. Electric Arc Furnace with at least one multi-layer panel according to claim 1 along its upper shell.
